(19) United States
(12) Patent Application Publication
(10) Pub. No.: US 2009/0277075 A1
(43) Pub. Date: Nov. 12, 2009

(54) BEE, WASP AND OTHER FLYING AND NESTING INSECTS IMMOBILIZATION AND EXTERMINATION

(76) Inventors: Jack V. Smith, Asheville, NC (US); George Ettwein, Asheville, NC (US)

Correspondence Address: Jack Smith, PO Box 156, Arden, NC, 28704, US

(21) Appl. No.: 12/116,782

(22) Filed: May 7, 2008

(51) Int. Cl. A01M 1/14; A01M 7/00

(52) U.S. Cl. 43/114; 43/132.1; 43/900

(57) ABSTRACT

This invention provides a safe and effective product for extinguishing of insects (particularly Wasps, Bees and other flying insects). The device comprises a spray can or other spraying type device containing glue which can be sprayed in conjunction with an insecticide which is effective against nesting and/or other flying insects. When the user approaches a hornet's nest the individual can spay this device at the opening of the hole which will effectively seal the hole (entrance to the nest) and kill the inhabitants. Typically (prior to this invention) one would spray a wasp nest and run for their lives in hope of not getting stung. This device will saves thousands or lives and will be a significant advance in the art of preventing medical and loss of work and other cost due to bee and wasp stings.

### BACKGROUND OF THE INVENTION

1. Field of the Invention

The present invention is a method that is herein described as a Bee, Wasp and other flying and nesting insects immobilization and extermination method (instant invention/present art) that will be referred to as “Bee Freeze” that will provide an inventive methodology that will saves thousands of lives of individuals that are allergic to stings from bees, yellow jackets, wasp, hornets and other insects. Currently when an individual uses a poisonous spray to spray bee or a wasp nest to kill the insects the insect can still fly toward the attacker and sting the individual. It is well known in the art the danger from bee and wasp stings and how without immediate medical individuals can rapidly die from such stings. This novel invention provides a way for individuals that are trying to clear doorways, garages, homes, etc., from the presence of bees, yellow jackets, wasp and nest without getting stung by freezing (immobilizing) the bees, yellow jackets, wasps and other insect where they are at the time of spraying. In other words, once sprayed with Bee Freeze the insect is immobilized (stuck) to the nest and the poison does not have to be as toxic or concentrated as current solutions on the markets because the insects cannot go anywhere and will be exposed to the poison for a longer period of time. This device even allows for immobilization of the insect without the poison. This is achieved by the addition of a small amount of a liquid adhesive to a can of insect poison under pressure or present in a spray bottle without poison. Experiments have shown that once the insects are sprayed they are completely immobilized (frozen to the nest) and unable to fly and sting the attacker.

The present art will improve the current technology of killing bees, yellow jackets, hornets, killer bees, wasps and other nesting (hives, nests, etc.), borrowing, jumping and attacking insects. With the increase of bee, hornets, yellow jacket and wasp attacks, the more killer bee attacks in the US this invention will be a powerful aide for public safety and welfare by providing unexpected results as it relates to convenience, health and safety. The present art and novel new invention provides a completely new principle of operation for the destruction of dangerous flying insects such as bee, wasp and other insects. In fact this novel new art provides unsuggested combination of old and antiquated technology that does not relate to the present art.

2. Description of the Related Art

The use of different types of insecticides and methods to kill insects is well known in the art. All of the present art as available in stores and shops rely on the spraying of the insects from some distance and then the individuals running for their lives in hope of not getting stung. Additionally, the present art of extermination of bees, etc., relies on very toxic poisons that in themselves are harmful. This invention can use poisons in a much more diluted form or no poison at all to insure the death of the insects inside of a nest, hive as they are immobilized/frozen to the nest. This novel and new invention overcomes previous limitations. Ultimately, this invention will save lives.

Different attempts at providing an effective insect poison or killing techniques are known. No prior art is found that describes the present arts novelty. However for discussion purposes the following systems are in the same field but have no relative bearing on the present art. U.S. Pat. No. 6,892,492 is a patent for designing an insect trap that uses combustible fuel to incinerate the insects. This prior art has nothing to do with nor does it teach, elaborate or reference anything to do with immobilizing and killing bees, wasps or other nesting, flying and painfully stinging insects at their nesting site or position when sprayed with an adhesive poisonous spray. The wasp is any insect in the order Hymeoptera and suborder Apocrita that is not a bee or ant. Note that bees are flying insects closely related to wasps and ants. U.S. Pat. No. 6,449,688 is another insect trap that uses a combustible gas to include the use of carbon dioxide This prior art has nothing to do with nor does it teach, elaborate or reference anything to do with immobilizing and killing bees, wasps or other nesting, flying and painfully stinging insects at their nesting site or position when sprayed with an adhesive poisonous spray. The wasp is any insect in the order Hymeoptera and suborder Apocrita that is not a bee or ant. Note that bees are flying insects closely related to wasps and ants. U.S. Pat. No. 6,898,896 is another insect trap for mosquitos. This prior art has nothing to do with nor does it teach, elaborate or reference anything to do with immobilizing and killing bees, wasps or other nesting, flying and painfully stinging insects at their nesting site or position when sprayed with an adhesive spray or an adhesive poisonous spray. The wasp is any insect in the order Hymeoptera and suborder Apocrita that is not a bee or ant. Note that bees are flying insects closely related to wasps and ants. When one does a search on the USPTO, library and other sites no relative patent teaching, patent pending, publication, or reference is made to any searches using the terms, bee killer, wasp killer, bee immobilizer, wasp immoblizer, extermination, etc.

While the prior art provides methods trapping insects and the use of insecticides none provide the novel ability of the present device which provides a method for the immobilizing and killing bees, wasps, yellow jackets or other nesting, flying and painfully stinging insects at their nesting site or position when sprayed with an adhesive spray or an adhesive poisonous spray. This new inventive technology (present art) is so new that it brings about a basic paradigm shift in thought with regards to the extermination or immobilization of insects. Why poison if you do not have to? Why run if you can safely spray and watch. The entire prior art suffers from the fact that once you use a spray to kill a bee you have to run for your life. There are additional drawbacks to the prior art but need not be mentioned now. These are just some, but not all, of the limitations of the prior art.

### SUMMARY OF THE INVENTION

The present invention is designed to advance the art of protecting oneself from stinging flying and nesting insects. The present invention is a method that is herein described as a bee, wasp, yellow jacket, hornet, and other flying and nesting insects immobilization and extermination method that will be referred to as “Bee Freeze” that will provide an inventive methodology that will saves thousands of lives of individuals that are allergic to stings from Bees, wasp and other insects. This invention provides a marked in improvement in the art of public safety against the threat of painful stinging insects. The present art requires minimal number of parts, increase the safety of the consumer and will be cost effective in that it should lower the risk of stings (e.g. the use of medications, hospitalizations from stings and loss of work). Another object of the present invention is to provide a method that allows for an easily adaptable method of use and is fully enabled.

The primary object of the present invention is to immobilize the target insect (bee, wasp, etc.) onto the nest or nesting area whether a nest is attached or bound to a structure or incorporates a hole in the ground or other area containing a nest or accumulation of insects. This is achieved by using an adhesive which will interfere with the functions of the wings. The experiments have shown that very little use of an adhesive will prevent the insects from being able to fly. The addition of a poison although not necessary will increase the speed at which the insects die. Insects do not breathe using lungs instead they use tracheal respiration in order to transport oxygen through system of tubes in their bodies called tracheae which is connected to the outside world by a series of holes in their cuticle called spiracles. Through these spiracles oxygen to and carbon dioxide are transported. Once the wings are immobilized by the adhesive and the spiracles are clogged up the insect dies from suffocation and impact from falling. While spraying it has been observed that some of the insect will be immobilized to the nest.

The present example of the invention provides a method for immobilization of the target insect (bee, wasp, yellow jacket, hornet, etc.) and subsequent death of the insect through suffocation and/or impact and poison being characterized by the following steps:
a) Spraying the insect with an adhesive spray;
b) the said insect will lose the ability to mobilize and

Other aspects and advantages of the present invention appear more clearly from reading the following detailed description of the preferred embodiment of the invention, given by way of example. A thorough search of the literature reveals no relative art resembling this technology; therefore, this invention is clearly a novel in creation, and is not obvious to anyone skilled in the art, there are certain aspects of the present art that can be found in the prior art but no prior art has advanced the art of data storage/retrieval as much as the present art. This art solves an unrecognized problem that was never before even recognized. Specifically this novel art allows for the user the unexpected results of not having to run for their life every time they spray a wasp nest. The elderly, handicapped, and general public will benefit from the novel aspect of this inventions ability to completely immobilize and kill dangerous, painful stinging insects. This was never conceived until the present art and advances the art significantly. In fact the prior art as cited teach away from the present art in that it teaches the use trapping the insect instead of not trapping them but immobilizing them.

### DETAILED DESCRIPTION OF THE PREFERRED EMBODIMENTS

The present invention will now be described more fully with reference to the accompanying drawings, in which the preferred embodiments of the present art invention are shown. It is understood from the embodiments that a person skilled in the art may make variations and modifications without departing from the spirit and scope of the invention. Such as changing the amount of glue (adhesive), the use of poison and the application of the glue other than by spray bottle or container. The type of adhesive, poison, spay bottle or method of application spraying.

Referring now to the present example of the invention provides a method of immobilizing the insect (e.g. bees, wasp, yellow jacket, hornets or other stinging insects) such that the insects are incapable of flying at the attacker and stinging them. In most cases the insects will be adhered to the surface of the nest by the glue. The method can use glue or a glue and poison combination, all types of glues from natural glues and adhesives made from milk to synthetic blues and adhesives. The poisons can be natural or synthetic as well from acids or bases, from agent orange to DDT. This device was invented after extensive trial and error to develop the correct and effective product for the safe extinguishing of insects (particularly Wasps, Bees and other flying insects). The device comprises a spray can or other spraying type device containing glue which can be sprayed in conjunction with an insecticide which is effective against nesting and/or other flying insects. When the user approaches a hornet's nest the individual can spray this device at the opening of the hole which will effectively seal the hole (entrance to the nest) and kill the inhabitants or at a nest of wasp attached to a wall and spray the insects effectively preventing them from flying at the individual spraying the Bee Freeze. Typically (prior to this invention) one would spray the nest and run for their lives in hope of not getting stung. This device will saves thousands or lives and will be a significant advance in the art of preventing medical and loss of work and other cost due to bee and wasp stings, and the method being characterized by the following steps:
a) Spraying the insect with an adhesive spray;
b) the said insect will lose the ability to mobilize and die.

The simplicity and novelty of the invention is unmatched in the art. This device could be easily manipulated to by adding poison to the glue to speed up the death of the insects and effect on the nest area such as immobilization and poisoning to help insure that the insects do come back. This technology will increase public safety and protect life as a minimum.

### EXAMPLE 1

To further explain in a brief and concise way the present art is a method for immobilizing insects causing them to be unable to fly, attack and sting the individual applying the Bee Freeze wherein the following is required;
a. a container that can hold the contents of glue;
b. the said container can be either pressurized by a gas or manual pumped;
c. the said contents within the container can sprayed onto a nest of insects or individual insect causing the insect to become immobilized preventing it from flying at the attacker. Even if the insect is in flight the adhesive from the container will cause it to lose the ability of flight.

The invention has been described in detail with particular reference to a preferred embodiment and the operation thereof and it is understood that variations, modifications, and substitution of equivalent means can be effected and still remain within the spirit and scope of the invention. And all such modifications and variations are to be included within the scope of the invention as defined in the appended claims.

### EXAMPLE 2

To further explain in a brief and concise way the present art is a method for immobilizing insects causing them to be unable to fly, attack and sting the individual applying the Bee Freeze wherein the following is required;
a. container that can hold the contents of glue and poison;
b. the said container can be either pressurized by a gas or manual pumped;
c. the said contents within the container can sprayed onto a nest of insects or individual insect causing the insect to become immobilized preventing it from flying at the attacker. Even if the insect is in flight the adhesive from the container will cause it to lose the ability of flight. The poison within the container will ensure that all of the insects in the nest, hole or other occupied area will die from the poison as well as the adhesive.

### EXAMPLE 3

To further explain in a brief and concise way the present art is a method for immobilizing insects causing them to be unable to fly, to attack and sting the individual applying the Bee Freeze wherein the following is required;
a. A immobilization device for insects, comprising: a pressurized container comprising, a button or device attached to the container that can be activated that will allow the contents of the pressurized container to escape in the form of a spray, the container which allows for the containment of fluid under pressure, the fluid made up of an adhesive, such that when said contents of are released in a spray at insects, wherein said insects will be immobilized by the said adhesive.

### EXAMPLE 4

To further explain in a brief and concise way the present art is a method for immobilizing insects causing them to be unable to fly, to attack and sting the individual applying the Bee Freeze wherein the following is required;
a. A immobilization device for insects, comprising: a pressurized container comprising, a button or device attached to the container that can be activated that will allow the contents of the pressurized container to escape in the form of a spray, the container which allows for the containment of fluid under pressure, the fluid made up of an adhesive and insect poison, such that when said contents of are released in a spray at insects, wherein said insects will be immobilized and killed by the said adhesive.

It is understood that this invention could be used against other stinging and biting insects such as ants, spiders, horse flies, etc., and the nest, webs or others areas that the insects in general may nest (e.g. set up residence). It is understood that modifications can be made to the device without departing from the spirit, novelty and scope of the invention. This device is for the immobilization of insects, comprising a pressurized container which can be purchased or manufactured by anyone trying to enable this device. It is often been stated that a device is not novel or enabled even though there will be no finding in prior art, history or any teaching of the said device. In an effort to prevent this sort of event from happening we want to make this invention painstaking clear so that anyone could enable this art. So to continue, the pressurized container, can (cylinder), of pressurized air can be purchased at your local hardware store or online, an activation device attached to the container that when activated that will allow the contents of the pressurized container to cause the escape of the adhesive held in the container in the form of a spray which of course more simply put, the button on top of a can of air (or exactly like the button on a can of spray paint) can be or could be a button used to pump air into the pressurized can by only squeezing it partially to pressurize the can with room air and then once the button or trigger is pressed completely it allows the pressurized air to escape with the contents of the attached container, the container itself allows for the containment of fluid, the fluid is made up of an adhesive or adhesive and poison, or adhesive and perfume etc., such that when the button is activated releasing pressure from the can of pressurized air (or gas of some form, preferable non-reactive such as room air, helium or nitrogen) which then in turns causes the adhesive fluid from the container to exit the device the fluid then comes in contact with and insects in the form of a spray, stream, jet, etc., immobilizing the said insect to its nest or stopping the insect from flying or preventing the insect from being able maintain flight.

The invention has been described in detail with particular reference to a preferred embodiment and the operation thereof and it is understood that variations, modifications, and substitution of equivalent means can be effected and still remain within the spirit and scope of the invention. And all such modifications and variations are to be included within the scope of the invention as defined in the appended claims.

That which is claimed is:

1. A immobilization device for insects, comprising: a pressurized container, an activation device attached to the container that when activated that will allow the contents of the pressurized container to escape in the form of a spray, the container which allows for the containment of fluid, the fluid made up of an adhesive, such that when said contents of are released in a spray at insects immobilizes said insects with said adhesive.
